(19) United States
(12) Patent Application Publication
(10) Pub. No.: US 2008/0204324 A1
(43) Pub. Date: Aug. 28, 2008

(54) Patch Antenna and Method for Producing a Patch Antenna

(75) Inventors: Yasuyuki Okamura, Osaka (JP); Kazuhiro Kitatani, Osaka (JP)

Correspondence Address: DARBY & DARBY P.C., P.O. BOX 770, Church Street Station, New York, NY, 10008-0770, US

(73) Assignee: OSAKA UNIVERSITY, Suita-shi (JP)

(21) Appl. No.: 11/572,697

(22) PCT Filed: Jul. 25, 2005
(86) PCT No.: PCT/JP05/13598

§ 371 Date: Jan. 25, 2007

(30) Foreign Application Priority Data
Jul. 28, 2004 (JP) 2004-220909

(51) Int. Cl. H01Q 1/38; H01P 11/00

(52) U.S. Cl. 343/700 MS; 29/600

(57) ABSTRACT

In the present invention, a patch antenna wherein electric waves in two frequency bands can be transmitted and received is provided with smaller dimensions and a lower cost than in the conventional arts. The patch antenna has a radiation electrode and a ground conductor disposed to oppose each other, and has dielectrics in the gap between the radiation electrode and the ground conductor. The radiation electrode and the ground conductor are made of a material being excellent in electric conductivity. The radiation electrode is rectangular in a plan view. A power supplying part is disposed at a position having substantially the same distance from the opposing two sides of the radiation electrode. The thickness of the dielectrics differs with a boundary located at the position of distance a from one terminal side of the radiation electrode in the longer-side direction of the radiation electrode.

### CROSS-REFERENCE TO PRIOR APPLICATIONS

This is a U.S. national phase application under 35 U.S.C. §371 of International Patent Application No. PCT/JP2005/013598, filed Jul. 25, 2005, and claims the benefit of Japanese Application No. 2004-220909, filed Jul. 28, 2004, both of which are incorporated by reference herein. The International Application was published in Japanese on Feb. 2, 2006 as International Publication No. WO 2006/011459 A1 under PCT Article 21(2).

### TECHNICAL FIELD

The present invention relates to a patch antenna and a method for producing a patch antenna, and more particularly to a patch antenna and a method for producing a patch antenna that can transmit and receive electromagnetic waves (hereafter referred to as electric waves) in two frequency bands even with an extremely simple construction.

### BACKGROUND ART

Wireless LAN that wirelessly connects computers is rapidly penetrating into homes and offices. A considerable scale reduction is required in an antenna that is used in communication such as wireless LAN, So that a patch antenna is widely used.

A general patch antenna 100 is an antenna of flat plane type that is constructed with a rectangular-shaped conductor (radiation electrode 101), dielectrics 102, and a grounded conductor 103, as shown in FIG. 14. A power supplying part S is disposed at a position that is offset (distance b) from the center C of the radiation electrode 101. The resonance frequency is determined by the shape of the radiation electrode 101, and the dielectric constant and the thickness of the dielectrics 102. When the shape of the radiation electrode 101 is rectangular (length of two sides: L, W), and the dielectrics 102 has a relative dielectric constant of ∈r and a thickness of h, the resonance frequency fᵣ is determined as shown in the equation (1) assuming L_{eff} to be the equivalent side length, ∈ₑ to be the effective dielectric constant, and c to be the speed of light considering the fringing effect.

$${f}_{r} = \frac{c}{2 {L}_{eff} \sqrt{{ɛ}_{e}}} \\ Here , \\ {L}_{eff} = L ( 1 + 0.824 \frac{h}{L} \cdot \frac{( {ɛ}_{e} + 0.3 ) ( ( \frac{W}{h} ) + 0.262 )}{( {ɛ}_{e} - 0.258 ) ( ( \frac{W}{h} ) + 0.813 )} ) \\ {ɛ}_{e} = \frac{{ɛ}_{r} + 1}{2} + \frac{{ɛ}_{r} - 1}{2} {( 1 + 10 \frac{h}{W} )}^{- \frac{1}{2}} . \qquad Equation 1$$

In the meantime, as a frequency band of wireless LAN, a 2.4 GHz band is currently dominant; however, a high-frequency band (5.2 GHz band) being excellent in communication speed and information quantity is becoming popular. Therefore, a patch antenna that can transmit and receive electric waves of two frequency bands is devised. A patch antenna for two-frequency transmittance and receiving has a construction such that first dielectrics having a radiation electrode disposed on a top surface thereof, second dielectrics having another radiation electrode disposed on a top surface thereof and having a grounded conductor disposed on a back surface thereof, and third dielectrics having a plurality of micro strip lines disposed on a back surface thereof are laminated (for example, see Patent Document 1). In the patch antenna disclosed in the Patent Document 1, the shapes of the respective radiation electrodes are different, so that the patch antenna can transmit and receive electric waves of two frequency bands that are determined by the shape (dimension) of each radiation electrode.

[Patent Document 1] Japanese Patent Application Laid-Open No. H07-249933

### DISCLOSURE OF THE INVENTION

### Problems to be Solved by the Invention

However, a patch antenna for two-frequency transmittance and receiving such as described above has raised a problem in that higher costs are inevitable because two radiation electrodes and two dielectrics are provided. Also, because of having a construction in which two radiation electrodes are disposed, the total thickness dimension including the dielectrics will be large, thereby raising a problem of making the scale reduction difficult.

The present invention has been made in view of such circumstances, and an object thereof is to provide a patch antenna such that, even with a construction having a smaller scale and a lower cost than in the conventional case, resonance can be made in the length direction and in the width direction (hereafter referred to as the longer-side direction and the shorter-side direction) of the second conductor, whereby electric waves in two frequency bands can be transmitted and received, by forming a construction such that the power supplying part is disposed at a position having substantially the same distance from the opposing two sides of the rectangular-shaped second conductor, and the thickness of the dielectrics differs with a boundary located at a line substantially parallel to the two sides.

Also, an object of the present invention is to provide a patch antenna such that, even if the position of disposing the power supplying part is arbitrarily taken, resonance can be made in the longer-side direction and in the shorter-side direction of the second conductor, whereby electric waves in two frequency bands can be transmitted and received, by forming a construction such that the thickness of the dielectrics differs with a boundary located at two lines that are substantially parallel to two pairs of two opposing sides of the rectangular-shaped second conductor.

Also, an object of the present invention is to provide a patch antenna such that, even with a construction having a smaller scale and a lower cost than in the conventional case, resonance can be made in the longer-side direction and in the shorter-side direction of the second conductor, whereby electric waves in two frequency bands can be transmitted and received, by forming a construction such that the power supplying part is disposed at a position having substantially the same distance from the opposing two sides of the rectangular-shaped second conductor, and the thickness of the dielectrics at a position corresponding to one side of the two sides is smaller than the thickness of the dielectrics at the other positions.

Also, an object of the present invention is to provide a patch antenna such that, even if the position of disposing the power supplying part is arbitrarily taken, resonance can be made in the longer-side direction and in the shorter-side direction of the second conductor, whereby electric waves in two frequency bands can be transmitted and received, by forming a construction such that the thickness of the dielectrics at a position corresponding to respective one side of two pairs of two opposing sides of the rectangular-shaped second conductor is smaller than the thickness of the dielectrics at the other positions.

Also, an object of the present invention is to provide a method of producing a patch antenna that enables production of a large amount of dielectrics having a desired thickness without a fear of generating production deviation and can produce a patch antenna with little deviation of the frequency band, by forming dielectrics with a differing thickness by bonding and fixing a plurality of dielectric flat plates having different thicknesses and disposing a first conductor and a second conductor on the formed dielectrics.

Further, an object of the present invention is to provide a method of producing a patch antenna that does not generate deviation in the frequency band caused by production deviation even if an opening part is formed by a cutting method such as the etching method and the sand blast method, by forming an opening part that penetrates in the thickness direction of a dielectric first flat plate, forming dielectrics with a recess by bonding and fixing the first flat plate having the opening part formed therein and a dielectric second flat plate having a thickness different from that of the first flat plate, and disposing a first conductor and a second conductor on the formed dielectrics.

### Means for Solving the Problems

The patch antenna according to a first aspect is a patch antenna in which a first conductor and a rectangular-shaped second conductor having a power supplying part are disposed to oppose each other, and having dielectrics provided in a gap between the first conductor and the second conductor, characterized in that said power supplying part is disposed at a position having substantially the same distance from the opposing two sides of said second conductor, and the thickness of said dielectrics differs with a boundary located at a line substantially parallel to said two sides.

In the first aspect, resonance can be made in the orthogonal longer-side and shorter-side directions of the second conductor because the thickness of the dielectrics differs at the boundary. In the longer-side direction of the second conductor, resonance is made in the frequency band that is determined by the length of the longer side of the second conductor and the thickness of the dielectrics deriving from the resonance in the longer-side direction. In the shorter-side direction of the second conductor, resonance is made in the frequency band that is determined by the length of the shorter side of the second conductor and the thickness of the dielectrics deriving from the resonance in the shorter-side direction.

Therefore, by constructing in such a manner that the thickness of the dielectrics differs at the boundary, electric waves of two frequency bands can be transmitted and received. Also, the patch antenna can transmit and receive electric waves in two frequency bands simply by providing one second conductor (radiation electrode) and one kind of dielectrics. This eliminates the need for providing a plurality of second conductors or providing plural kinds of dielectrics having different dielectric constants as in the conventional case, so that the number of constituent elements can be reduced and the cost can be reduced as compared with the conventional case.

The patch antenna according to a second aspect is a patch antenna in which a first conductor and a rectangular-shaped second conductor having a power supplying part are disposed to oppose each other, and having dielectrics provided in a gap between the first conductor and the second conductor, characterized in that the thickness of said dielectrics differs with a boundary located at two lines that are substantially parallel to two pairs of two opposing sides of said second conductor.

In the second aspect, the thickness of the dielectrics differs at two boundaries, so that resonance can be made in the orthogonal longer-side and shorter-side directions of the second conductor irrespective of the position of disposing the power supplying part. This allows a degree of freedom in the position of disposing the power supplying part.

The patch antenna according to a third aspect is characterized in that, in the first aspect or in the second aspect, said boundary is located at a position that overlaps with said second conductor.

In the third aspect, the boundary at which the thickness of the dielectrics changes is disposed at a position that overlaps with the second conductor. Therefore, the thickness of the dielectrics corresponding to one side of the longer side or the shorter side of the second conductor is different from the thickness of the dielectrics corresponding to the other side, so that resonance in the orthogonal longer-side and shorter-side directions of the second conductor can be generated with certainty.

The patch antenna according to a fourth aspect is a patch antenna in which a first conductor and a rectangular-shaped second conductor having a power supplying part are disposed to oppose each other, and having dielectrics provided in a gap between the first conductor and the second conductor, characterized in that said power supplying part is disposed at a position having substantially the same distance from the opposing two sides of said second conductor, and the thickness of said dielectrics at a position corresponding to one side of said two sides is smaller than the thickness of said dielectrics at the other positions.

In the fourth aspect, the thickness of the dielectrics in a region at a position corresponding to the longer side or the shorter side of the second conductor is smaller, so that resonance can be made in the longer-side direction and in the shorter-side direction of the second conductor. In the longer-side direction of the second conductor, resonance is made in a frequency band substantially corresponding to a single-element antenna having a length of the longer side of the second conductor and a thickness of the dielectrics deriving from the resonance in the longer-side direction. In the shorter-side direction of the second conductor, resonance is made in a frequency band substantially corresponding to a single-element antenna having a length of the shorter side of the second conductor and a thickness of the dielectrics deriving from the resonance in the shorter-side direction. Therefore, such a patch antenna can transmit and receive electric waves in two frequency bands simply by providing one second conductor and one kind of dielectrics. This eliminates the need for providing a plurality of second conductors or providing plural kinds of dielectrics having different dielectric constants as in the conventional case, so that the number of constituent elements can be reduced and the cost can be reduced as compared with the conventional case.

The patch antenna according to a fifth aspect is a patch antenna in which a first conductor and a rectangular-shaped second conductor having a power supplying part are disposed to oppose each other, and having dielectrics provided in a gap between the first conductor and the second conductor, characterized in that the thickness of said dielectrics at a position corresponding to respective one side of two pairs of two opposing sides of said second conductor is smaller than the thickness of said dielectrics at the other positions.

In the fifth aspect, the thickness of the dielectrics in a region at a position corresponding to one longer side and shorter side of the second conductor is smaller, so that resonance can be made in the longer-side direction and in the shorter-side direction of the second conductor irrespective of the position of disposing the power supplying part. This allows a degree of freedom in the position of disposing the power supplying part.

The patch antenna according to a sixth aspect is characterized in that, in any of the first aspect to the fifth aspect, said dielectrics has a through-hole that penetrates in the thickness direction, and is provided with a third conductor that connects from the first conductor side to said power supplying part via the through-hole.

In the sixth aspect, when receiving an electric wave, the second conductor is oscillated by the arriving electric wave, and is forwarded to the first conductor side through the third conductor via the through-hole disposed in the dielectrics so as to be output as a signal. Also, when an electric wave is to be transmitted, a signal is forwarded to the second conductor through the third conductor to resonate the second conductor, thereby to be transmitted as an electric wave. Therefore, signals related to an electric wave can be given or taken out not from the second conductor side but from the first conductor side.

The method of producing a patch antenna according to a seventh aspect is a method for producing a patch antenna in which a first conductor and a second conductor are disposed to oppose each other, and having dielectrics with a differing thickness provided in a gap between the first conductor and the second conductor, characterized by including a step of forming dielectrics with a differing thickness by bonding and fixing a plurality of dielectric flat plates having different thicknesses, and a step of disposing a first conductor and a second conductor on the formed dielectrics.

In the seventh aspect, a plurality of dielectric flat plates having different thicknesses are prepared, and these flat plates are bonded and fixed to form dielectrics with a differing thickness. A patch antenna is produced by disposing a first conductor and a second conductor on the formed dielectrics. Since dielectrics with a differing thickness is formed by bonding and fixing flat plates, there is no fear of generating production deviation in the thickness of the dielectrics, so that dielectrics having a desired thickness can be produced in a large amount.

The method of producing a patch antenna according to an eighth aspect is a method for producing a patch antenna in which a first conductor and a second conductor are disposed to oppose each other, and having dielectrics with a recess provided in a gap between the first conductor and the second conductor, characterized by including a step of forming an opening part that penetrates in the thickness direction of a dielectric first flat plate, a step of forming dielectrics with a recess by bonding and fixing the first flat plate having the opening part formed therein and a dielectric second flat plate having a thickness different from that of the first flat plate, and a step of disposing a first conductor and a second conductor on the formed dielectrics.

In the eighth aspect, an opening part that penetrates in the thickness direction of a dielectric first flat plate is formed, and dielectrics with a recess is formed by bonding and fixing the first flat plate having the opening part formed therein and a dielectric second flat plate having a thickness different from that of the first flat plate. A patch antenna is produced by disposing a first conductor and a second conductor on the formed dielectrics. Deviation in the frequency band caused by production deviation is not generated even if the opening part is formed by a cutting method such as the etching method and the sand blast method.

### EFFECTS OF THE INVENTION

The present invention has a construction such that a power supplying part is disposed at a position having substantially the same distance from the opposing two sides of a rectangular-shaped second conductor, and the thickness of the dielectrics differs with a boundary located at a line substantially parallel to the two sides. Therefore, even with a construction having a smaller scale and a lower cost than in the conventional case, resonance can be made in the longer-side direction and in the shorter-side direction of the second conductor, whereby electric waves in two frequency bands can be transmitted and received.

Also, the present invention has a construction such that the thickness of the dielectrics differs with a boundary located at two lines that are substantially parallel to two pairs of two opposing sides of the rectangular-shaped second conductor. Therefore, even if the position of disposing the power supplying part is arbitrarily taken, resonance can be made in the longer-side direction and in the shorter-side direction of the second conductor, whereby electric waves in two frequency bands can be transmitted and received.

Also, the present invention has a construction such that the power supplying part is disposed at a position having substantially the same distance from the opposing two sides of the rectangular-shaped second conductor, and the thickness of the dielectrics at a position corresponding to one side of the two sides is smaller than the thickness of the dielectrics at the other positions. Therefore, even with a construction having a smaller scale and a lower cost than in the conventional case, resonance can be made in the longer-side direction and in the shorter-side direction of the second conductor, whereby electric waves in two frequency bands can be transmitted and received.

Also, the present invention has a construction such that the thickness of the dielectrics differs with a boundary located at two lines that are substantially parallel to two pairs of two opposing sides of the rectangular-shaped second conductor. Therefore, even if the position of disposing the power supplying part is arbitrarily taken, resonance can be made in the longer-side direction and in the shorter-side direction of the second conductor, whereby electric waves in two frequency bands can be transmitted and received.

Therefore, for example, although a 2.4 GHz band is currently dominant in a wireless LAN that wirelessly connects computers, a 5.2 GHz band being excellent in communication speed and information quantity is becoming popular, so that the present invention is useful as a small-scale and light-weight antenna that meets these two frequency bands.

Also, according to the present invention, a patch antenna is produced by forming dielectrics with a differing thickness by bonding and fixing a plurality of dielectric flat plates having different thicknesses and disposing a first conductor and a second conductor on the formed dielectrics. Therefore, production of a large amount of dielectrics having a desired thickness is enabled without a fear of generating production deviation, and a patch antenna with little deviation of the frequency band can be produced.

Further, according to the present invention, a patch antenna is produced by forming an opening part that penetrates in the thickness direction of a dielectric first flat plate, forming dielectrics with a recess by bonding and fixing the first flat plate having the opening part formed therein and a dielectric second flat plate having a thickness different from that of the first flat plate, and disposing a first conductor and a second conductor on the formed dielectrics. Therefore, excellent effects are produced such as no generation of deviation in the frequency band caused by production deviation even if the opening part is formed by a cutting method such as the etching method and the sand blast method.

### BRIEF DESCRIPTION OF THE DRAWINGS

FIG. 1 is a perspective view showing a structure of a patch antenna according to the embodiment 1 of the present invention;

FIG. 2 is a structural cross-sectional view taken on the line II-II of FIG. 1;

FIGS. 3(a) to 3(g) are descriptive views showing one example of a method of producing the patch antenna according to the embodiment 1 of the present invention;

FIG. 4 is a graph showing reflection characteristics of the patch antenna of Example 1;

FIGS. 5(a) and 5(b) are graphs showing radiation characteristics of the patch antenna of Example 1;

FIG. 6 is a graph showing reflection characteristics of the patch antenna of Example 2.

FIGS. 7(a) and 7(b) are graphs showing radiation characteristics of the patch antenna of Example 2;

FIG. 8 is a structural cross-sectional view of a patch antenna according to the embodiment 2 of the present invention;

FIGS. 9(a) to 9(d) are descriptive views showing one example of a method of producing the patch antenna according to the embodiment 2 of the present invention;

FIG. 10 is a descriptive view showing another example of a method of producing the patch antenna according to the embodiment 2 of the present invention;

FIG. 11 is a perspective view showing a structure of a patch antenna according to the embodiment 3 of the present invention;

FIGS. 12(a) and 12(b) are structural cross-sectional views of a patch antenna according to the embodiment 3 of the present invention;

FIGS. 13(a) and 13(b) are structural cross-sectional views showing another example of a patch antenna according to the present invention; and

FIG. 14 is a perspective view showing a structure of a general patch antenna.

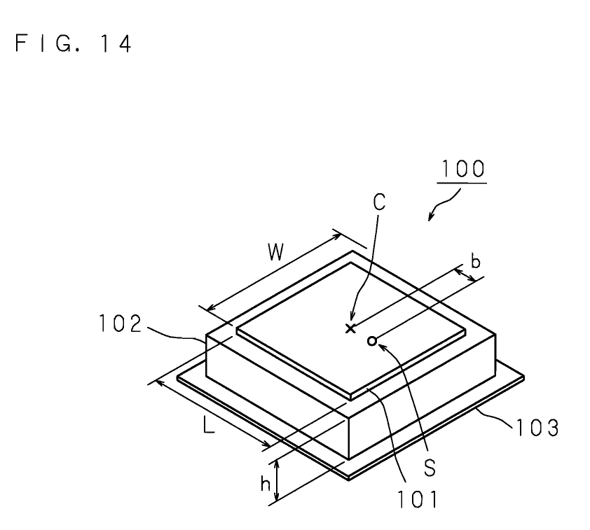

### DESCRIPTION OF THE NUMERALS

1, 2, 3 Patch antenna
11 Radiation electrode
12, 22, 32 Dielectrics
12a Through-hole
13, 51, 52 Grounded conductor
14 Connection pin
15 Coaxial connector
15a Inside conductor
15b Outside conductor
30a, 30b, 40, 40a, 40b, 42 Dielectric flat plate
31a, 31b, 41a, 41b Mask
45 Opening part
S, S′ Power supplying part

### BEST MODES FOR IMPLEMENTING THE INVENTION

Hereafter, the present invention will be described in detail on the basis of the drawings showing the embodiments thereof.

### Embodiment 1

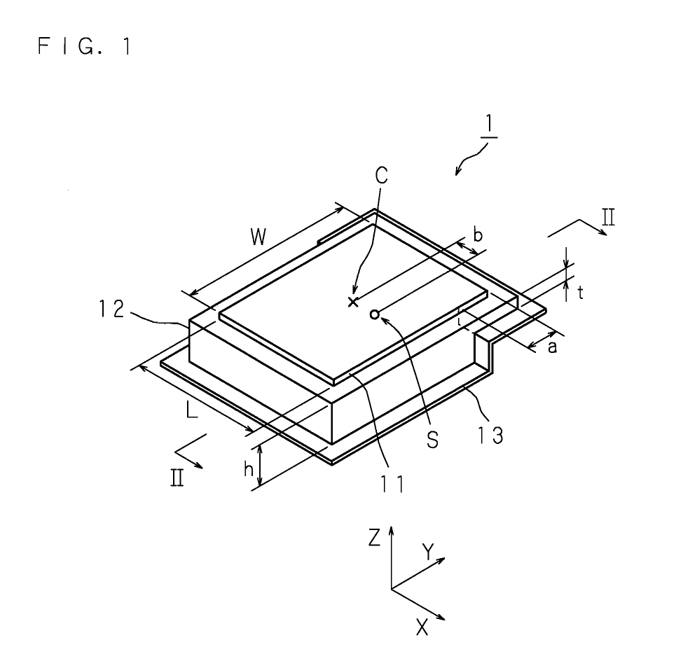

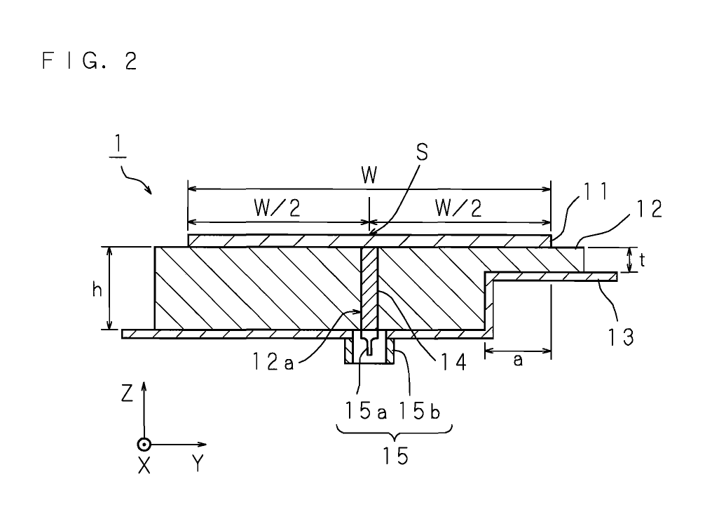

FIG. 1 is a perspective view showing a structure of a patch antenna according to the embodiment 1 of the present invention, and FIG. 2 is a structural cross-sectional view at the line II-II of FIG. 1.

In the patch antenna 1 according to the embodiment 1 of the present invention, a radiation electrode 11 being a second conductor and a grounded conductor 13 being a first conductor are disposed to oppose each other, and dielectrics 12 is provided between the radiation electrode 11 and the grounded conductor 13.

The radiation electrode 11 and the grounded conductor 13 are made of a material being excellent in electric conductivity such as copper, silver, or aluminum. The radiation electrode 11 has a rectangular shape as viewed in a plan view, and has a shorter-side length and a longer-side length of L and W, respectively. On the other hand, the grounded conductor 13 may have a shape larger than that of the radiation electrode 11 as viewed in a plan view, and the shape thereof is not particularly limited. A power supplying part S is disposed at a position having substantially the same distance from the opposing two sides (here, shorter sides) of the radiation electrode 11. In other words, the power supplying part S is disposed at a position spaced apart by a suitable length (distance b) from the center C of the radiation electrode 11 in the shorter-side direction (here, X direction) of the radiation electrode 11.

The dielectrics 12 is a dielectric substance having a relative dielectric constant of ∈r, and the thickness thereof differs with a boundary located at a line substantially parallel to the opposing two sides of the radiation electrode 11. In the present embodiment, the thickness of the dielectrics 12 differs with a boundary at a position of distance a from one terminal side of the radiation electrode 11 in the longer-side direction (here, −Y direction) of the radiation electrode 11. Here, the distance a is positive (a>0), and the boundary is disposed at a position that overlaps with the radiation electrode 11 as viewed in a plan view. Namely, the thickness of the dielectrics 12 in the left side region is h, and the thickness in the right side region is t (it is assumed that h>t), so that the shape of the dielectrics 12 is asymmetric relative to the center line of the opposing two sides (here, shorter sides) of the radiation electrode 11. In other words, the radiation electrode 11 is disposed so as to cover two dielectrics having different thicknesses.

Also, the dielectrics 12 has a through-hole 12a that penetrates in the thickness direction at a position corresponding to the power supplying part S. An electrically conductive connection pin 14 being a third conductor is inserted in the through-hole 12a. Here, the position of the through-hole 12a and the diameter of the through-hole 12a are adjusted so as to attain good impedance characteristics.

At the grounded conductor 13, a coaxial connector 15 is disposed. The inside conductor 15a of the coaxial connector 15 is connected to the power supplying part S via the through-hole 12a of the dielectrics 12, and the outside conductor 15b of the coaxial connector 15 is connected to the grounded conductor 13. The patch antenna 1 having such a construction can transmit and receive electric waves by connecting a not-illustrated communication apparatus to the coaxial connector 15. Namely, in the patch antenna 1, when receiving an electric wave, the radiation electrode 11 is oscillated by the arriving electric wave, and is forwarded to the coaxial connector 15 via the through-hole 12a so as to be output as a signal. Also, when an electric wave is to be transmitted, a signal that is input into the coaxial connector 15 is forwarded to the radiation electrode 11 via the through-hole 12a to resonate the radiation electrode 11, thereby to be transmitted as an electric wave. Of course, in mounting the patch antenna 1 onto an apparatus such as a wireless LAN card, there is no need to use the coaxial connector 15, and it is preferable to mount the patch antenna 1 directly onto an electronic circuit constituting the apparatus.

In the patch antenna 1, since the thickness of the dielectrics 12 differs at the boundary, resonance can be made in the orthogonal two directions (X direction and Y direction). In the X direction of the radiation electrode 11, resonance is made in a frequency band substantially corresponding to a single-element antenna that is determined by the length L of the shorter side of the radiation electrode 11. On the other hand, in the Y direction of the radiation electrode 11, resonance is made in a frequency band substantially corresponding to a single-element antenna that is determined by the length W of the longer side of the radiation electrode 11. In this manner, by constructing it so that the thickness of the dielectrics 12 differs at the boundary, electric waves in two frequency bands can be transmitted and received.

Also, the patch antenna 1 can transmit and receive electric waves in two frequency bands simply by providing one radiation electrode and one kind of dielectrics. This eliminates the need for providing a plurality of radiation electrodes or providing plural kinds of dielectrics having different dielectric constants as in the conventional case, so that the number of constituent elements can be reduced and the cost can be reduced as compared with the conventional case.

Next, a method of producing a patch antenna 1 having such a construction will be described.

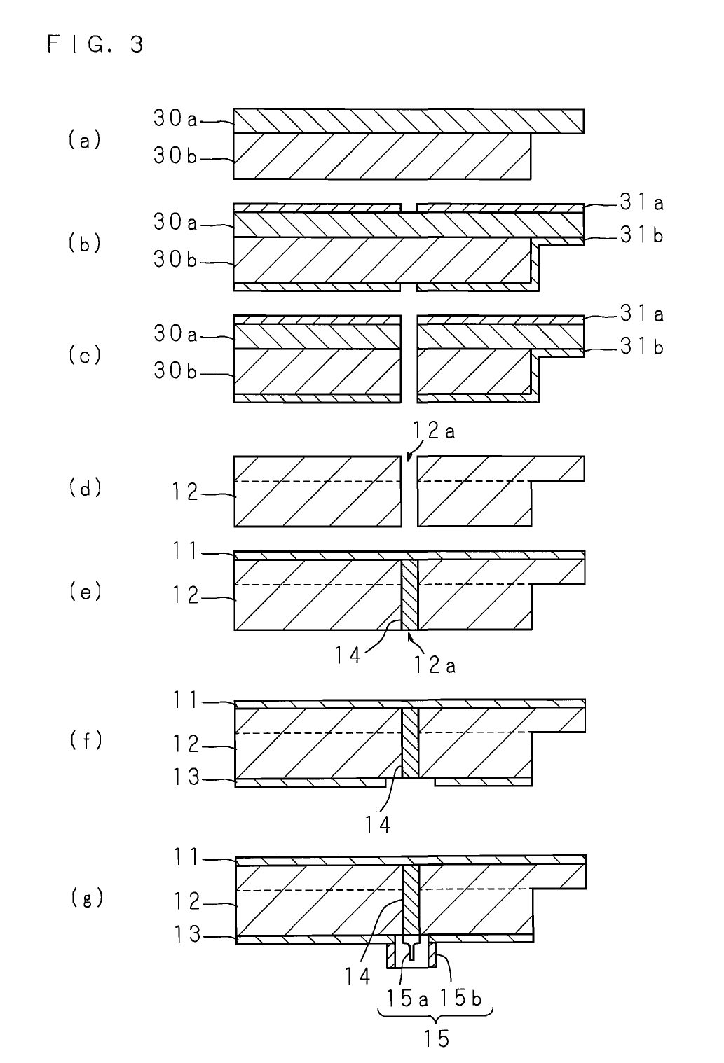

FIGS. 3(a) to 3(g) are descriptive views showing one example of a method of producing the patch antenna according to the embodiment 1 of the present invention.

First, dielectric flat plates 30a, 30b of the same kind (same material) respectively having a plate thickness of t and (h−t) are prepared, and the dielectric flat plates 30a, 30b are bonded and fixed with each other in a state of being stacked in the plate thickness direction (FIG. 3(a)). For example, an adhesive agent is applied on fixation surfaces of the dielectric flat plates 30a, 30b and, after the fixation surfaces of the dielectric flat plates 30a, 30b are stacked with each other, the solvent of the adhesive agent is evaporated to bond and fix the dielectric flat plate 30a and the dielectric flat plate 30b.

Next, masks 31a, 31b made of a material that will not be dissolved into an etchant for etching the dielectric flat plates 30a, 30b are applied onto the outside surfaces of the dielectric flat plates 30a, 30b (FIG. 3(b)). In the masks 31a, 31b, an opening pattern is disposed at a position where a through-hole will be formed. Then, the region that is not covered with the masks is etched by immersing the dielectric flat plates 30a, 30b having the masks 31a, 31b applied thereon into the etchant (FIG. 3(c)). Here, the etchant may be suitably selected in accordance with the material of the dielectric flat plates 30a, 30b. Of course, in addition to wet etching, it may be processed by dry etching by which the finish of the shape of the side wall (side wall) formed by etching will be sharp.

Then, by peeling the masks 31a, 31b off from the dielectric flat plates 30a, 30b, the dielectrics 12 with a differing thickness and having a through-hole 12a can be formed (FIG. 3(d)). Here, a mode of simultaneously etching from the upper surface and the lower surface has been described; however, the etching may be carried out either from the upper surface or from the lower surface if the etching time does not raise a problem. Of course, besides the etching method, the through-hole may be formed by the laser processing method or the like that is itself known in the art.

Further, a film-shaped radiation electrode 11 made of a material being excellent in electric conductivity such as copper or aluminum is applied onto the upper surface of the dielectrics 12, and a connection pin 14 is inserted into the through-hole 12a from the lower surface of the dielectrics 12 and connected to the radiation electrode 11 (FIG. 3(e)). Of course, when the thickness of the dielectrics 12 is several mm, a solder may be let to flow into the through-hole 12a so as to serve in lieu of the connection pin 14. On the other hand, a film-shaped grounded conductor 13 made of a material being excellent in electric conductivity such as copper or aluminum and having an opened pattern in the region of the through-hole 12a is applied onto the lower surface of the dielectrics 12 (FIG. 3(f)), and a coaxial connector 15 is disposed so as to achieve a state in which the inside conductor 15a of the coaxial connector 15 is connected to the connection pin 14, and the outside conductor 15b is connected to the grounded conductor 13 (FIG. 3(g)).

In this manner, a patch antenna provided with dielectrics having a differing thickness can be produced from two dielectric flat plates. The thickness of the dielectrics is one of the elements that determine the frequency band of the patch antenna. According to the above-described production method, the thickness of the dielectrics is determined respectively by the plate thickness t and (h−t) of the dielectric flat plates 30a, 30b prepared at the time of production. Therefore, there is no fear of generation of production deviation, and dielectrics having a desired thickness can be produced in a large amount. As a result, a patch antenna with little deviation in the frequency band can be produced.

Here, before bonding and fixing the dielectric flat plates 30a, 30b, a through-hole may be formed in each of the dielectric flat plates 30a, 30b and, thereafter, the dielectric flat plates 30a, 30b may be bonded and fixed so that the respective through-holes will be connected.

Also, one dielectric flat plate may be processed into dielectrics with a differing thickness by using a cutting method such as the etching method and the sand blast method. When a cutting method such as the etching method and the sand blast method is used, the cutting depth can be adjusted by controlling the etching time and the time of ejecting a grinding material, respectively. However, it goes without saying that there is a fear of generation of production deviation by the etching method and the sand blast method.

Further, the radiation electrode 11 and the grounded conductor 13 may be vapor-deposited onto the dielectrics 12 by the plating method, and the method of production may be suitably changed in accordance with the size and the thickness of the radiation electrode 11 and the grounded conductor 13.

### EXAMPLE 1

Next, as the Example 1, a patch antenna 1 having L=34 mm, W=46 mm, h=1.6 mm, t=0.5 mm, ∈r=2.53, and a=5.5 mm was produced, and the characteristics thereof were evaluated.

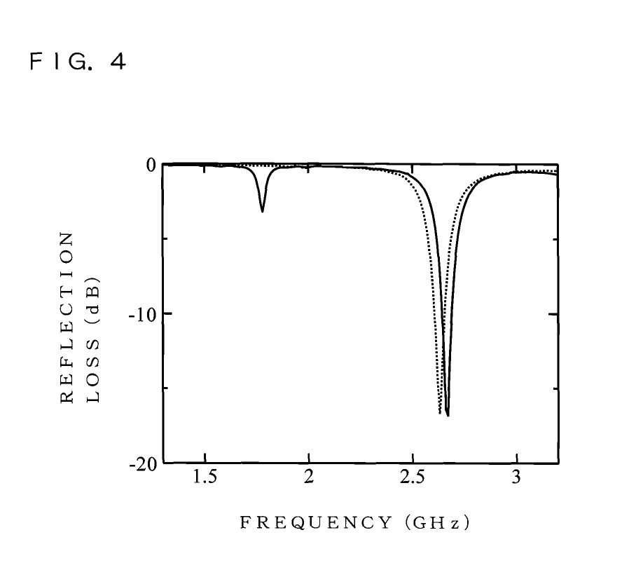

FIG. 4 is a graph showing the reflection characteristics of the patch antenna of the Example 1, where the lateral axis of FIG. 4 represents the frequency, and the longitudinal axis represents the reflection loss.

As shown by the solid line of FIG. 4, the patch antenna 1 has two peaks at 1.78 GHz and at 2.66 GHz, and the reflection losses at 1.78 GHz and at 2.66 GHz are −3 dB and −17 dB, respectively. Here, a conventional patch antenna, namely a patch antenna having a constant thickness (here, 1.6 mm) of the dielectrics has a peak only at 2.6 GHz, as shown by the broken line of FIG. 4. Namely, the patch antenna 1 according to the present invention can transmit and receive electric waves in two frequency bands because of having a different thickness of the dielectrics at a boundary thereby generating resonance in two orthogonal directions.

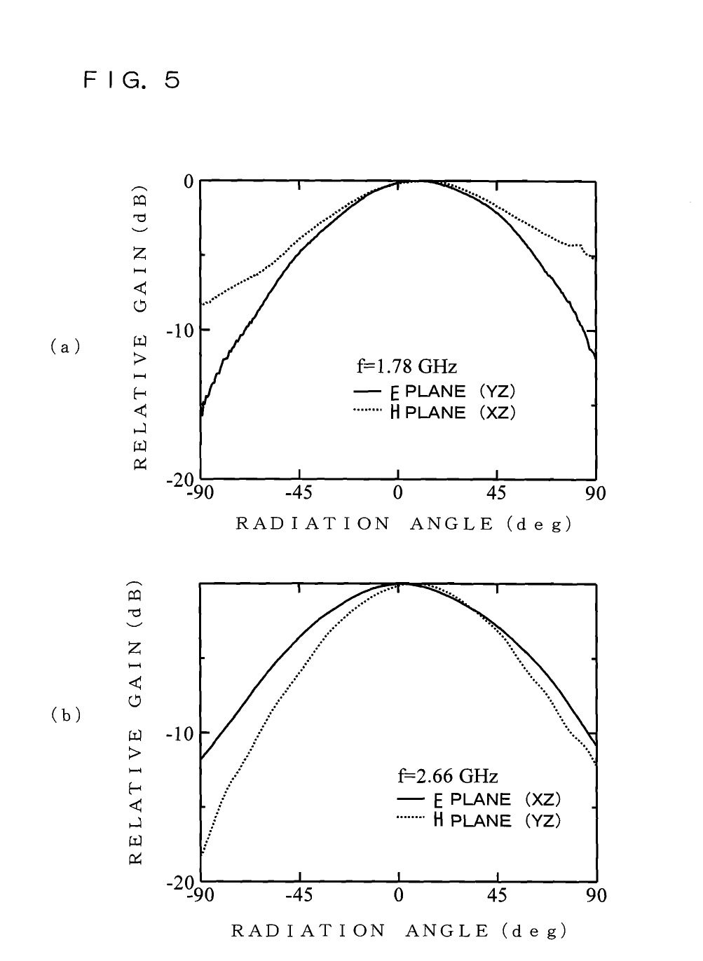

FIGS. 5(a) and 5(b) are graphs showing radiation characteristics of the patch antenna of the Example 1, where FIG. 5(a) shows the radiation characteristics at 1.78 GHz, and FIG. 5(b) shows the radiation characteristics at 2.66 GHz. Here, the lateral axis represents the radiation angle, and the longitudinal axis represents the relative gain. With regard to the radiation angle, the angle of the Z axis direction is defined as being 0 deg.

Since the electric wave of the 1.78 GHz band derives from the resonance in the longer-side direction (Y direction), the YZ plane is the E plane, and the XZ plane is the H plane. The solid line in FIG. 5(a) shows the radiation characteristics in the E plane (YZ plane), and the broken line in FIG. 5(a) shows the radiation characteristics in the H plane (XZ plane). As will be understood from the figure, the patch antenna has a good radiation pattern in the E plane and in the H plane with respect to the 1.78 GHz band.

On the other hand, since the electric wave of the 2.66 GHz band derives from the resonance in the shorter-side direction (X direction), the XZ plane is the E plane, and the YZ plane is the H plane. The solid line in FIG. 5(b) shows the radiation characteristics in the E plane (XZ plane), and the broken line in FIG. 5(b) shows the radiation characteristics in the H plane (YZ plane). As will be understood from the figure, the patch antenna has a good radiation pattern in the E plane and in the H plane with respect to the 2.66 GHz band as well.

### EXAMPLE 2

Similarly, as the Example 2, a patch antenna 1 having L 15.5 mm, W=36 mm, h=1.6 mm, t=0.4 mm, ∈r=2.53, and a=3 mm was produced, and the characteristics thereof were evaluated.

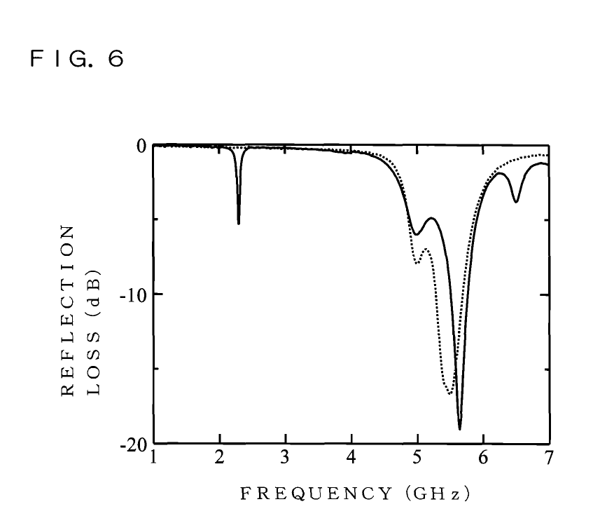

FIG. 6 is a graph showing the reflection characteristics of the patch antenna of the Example 2, where the lateral axis of FIG. 6 represents the frequency, and the longitudinal axis represents the reflection loss.

As shown by the solid line of FIG. 6, the patch antenna 1 has two peaks at 2.29 GHz and at 5.62 GHz, and the reflection losses at 2.29 GHz and at 5.62 GHz are −5.5 dB and −19 dB, respectively. Here, a conventional patch antenna, namely a patch antenna having a constant thickness (here, 1.6 mm) of the dielectrics has a peak only at 5.5 GHz, as shown by the broken line of FIG. 6.

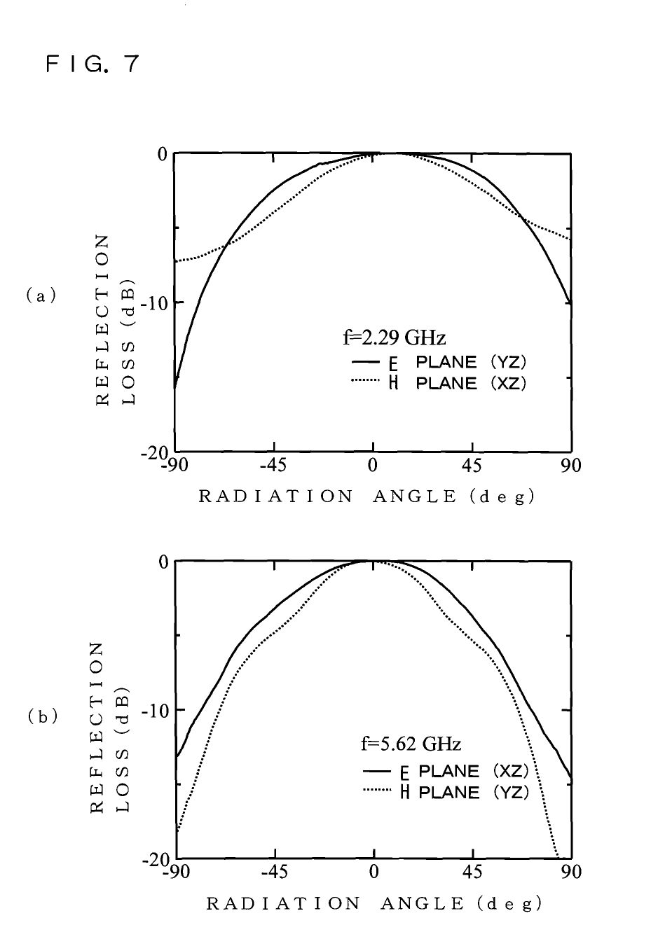

FIGS. 7(a) and 7(b) are graphs showing radiation characteristics of the patch antenna of the Example 2, where FIG. 7(a) shows the radiation characteristics at 2.29 GHz, and FIG. 7(b) shows the radiation characteristics at 5.62 GHz. Here, the lateral axis represents the radiation angle, and the longitudinal axis represents the relative gain. With regard to the radiation angle, the angle of the Z axis direction is defined as being 0 deg.

Since the electric wave of the 2.29 GHz band derives from the resonance in the longer-side direction (Y direction), the YZ plane is the E plane, and the XZ plane is the H plane. The solid line in FIG. 7(a) shows the radiation characteristics in the E plane (YZ plane), and the broken line in FIG. 7(a) shows the radiation characteristics in the H plane (XZ plane). As will be understood from the figure, the patch antenna has a good radiation pattern in the E plane and in the H plane with respect to the 2.29 GHz band.

On the other hand, since the electric wave of the 5.62 GHz band derives from the resonance in the shorter-side direction (X direction), the XZ plane is the E plane, and the YZ plane is the H plane. The solid line in FIG. 7(b) shows the radiation characteristics in the E plane (XZ plane), and the broken line in FIG. 7(b) shows the radiation characteristics in the H plane (YZ plane). As will be understood from the figure, the patch antenna has a good radiation pattern in the E plane and in the H plane with respect to the 5.62 GHz band as well.

Here, the Example 1 shows a construction example of a patch antenna commonly used for two frequencies that can transmit and receive electric waves in two frequency bands of 1.78 GHz and 2.66 GHz, and the Example 2 shows a construction example of a patch antenna commonly used for two frequencies that can transmit and receive electric waves in two frequency bands of 2.29 GHz and 5.62 GHz. However, electric waves of two desired frequency bands can be transmitted and received by suitably adjusting the dimension of the radiation electrode 11 as well as the dielectric constant and the thickness of the dielectrics 12.

### Embodiment 2

In the embodiment 1, a patch antenna 1 provided with dielectrics 12 with a thickness of the left side region being h and a thickness of the right side region being t has been described. However, it may be a patch antenna provided with dielectrics in which the thickness at a position corresponding to one side of the four sides of the radiation electrode is smaller than the thickness at the other positions. The one produced as described above is the embodiment 2.

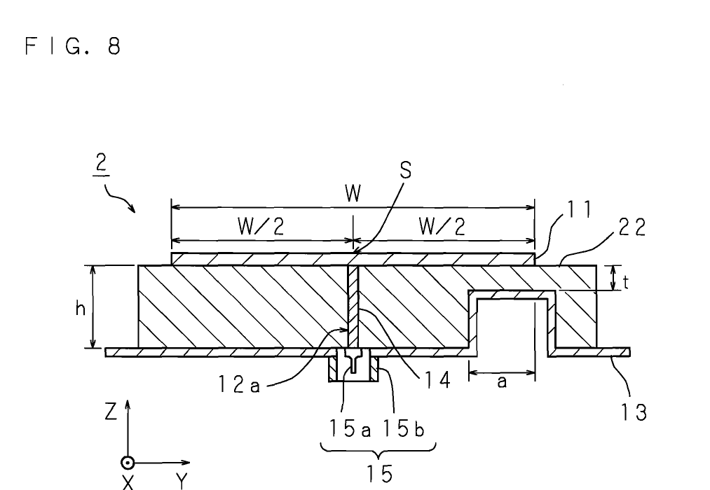

FIG. 8 is a structural cross-sectional view of a patch antenna according to the embodiment 2 of the present invention.

In the patch antenna 2 according to the embodiment 2 of the present invention, a radiation electrode 11 and a grounded conductor 13 are disposed to oppose each other, and dielectrics 22 is provided between the radiation electrode 11 and the grounded conductor 13 in the same manner as in the embodiment 1.

In the dielectrics 22, the thickness at a position corresponding to one terminal side of the radiation electrode 11 is smaller than the thickness at the other positions. The thickness of the dielectrics at the former position is t, and the thickness of the dielectrics at the latter positions is h (it is assumed that h>t). The other constructions are the same as those of the embodiment 1, so that the detailed description thereof will be omitted by denoting the corresponding parts with the same symbols.

The patch antenna 2 can transmit and receive electric waves in two frequency bands because the thickness at a position corresponding to one terminal side of the radiation electrode 11 is smaller so as to enable resonance in two orthogonal directions (X direction and Y direction) in the same manner as in the embodiment 1. In this case, the resonance frequency is such that the patch antenna is resonated at frequency bands substantially corresponding to single-element antennas that are respectively determined by the length L of the shorter side and the length W of the longer side of the radiation electrode 11.

Next, a method of producing the patch antenna 2 having such a construction will be described.

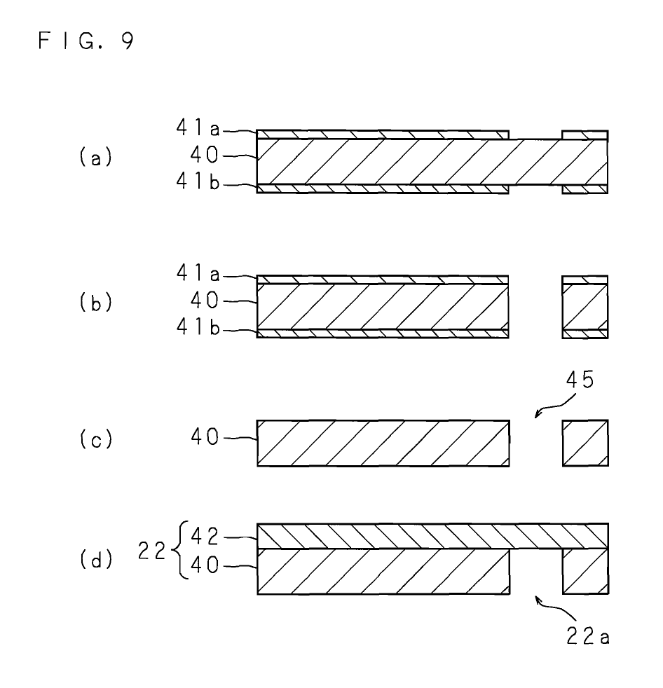

FIGS. 9(a) to 9(d) are descriptive views showing one example of a method of producing a patch antenna according to the embodiment 2 of the present invention.

First, a dielectric flat plate 40 having a plate thickness of (h-t) is prepared, and masks 41a, 41b made of a material that will not be dissolved into an etchant for etching the dielectric flat plate 40 are applied onto both surfaces of the dielectric flat plate 40 (FIG. 9(a)). The region that is not covered with the masks is etched by immersing the dielectric flat plate 40 having the masks 41a, 41b applied thereon into the etchant (FIG. 9(b)). Then, by peeling the masks 41a, 41b off from the dielectric flat plate 40, an opening part 45 that penetrates in the thickness direction is formed in the dielectric flat plate 40 (FIG. 9(c)).

Next, a dielectric flat plate 42 being the same kind (same material) as the dielectric flat plate 40 and having a plate thickness of t is prepared, and the dielectric flat plates 40, 42 are bonded and fixed in a state of being stacked respectively in the plate thickness direction (FIG. 9(d)). This can produce dielectrics 22 in which the thickness of the region of the recess 22a is t and the thickness of the other regions is h. The subsequent steps are similar to those of FIG. 3(b) to FIG. 3(g), so that the description thereof will be omitted.

In the present embodiment, the opening part 45 is formed in the dielectric flat plate 40 by using the etching method. The etching time may be set so that the opening part 45 penetrates through the dielectric flat plate 40, and the etching time may be set to be longer, for example, in consideration of the production deviation. In this manner, when an opening part that penetrates through a flat plate is to be formed, there will not be raised a problem caused by the production deviation even if the etching method is used. Of course, the opening part 45 may be formed in the dielectric flat plate 40 by using another cutting method (for example, the sand blast method).

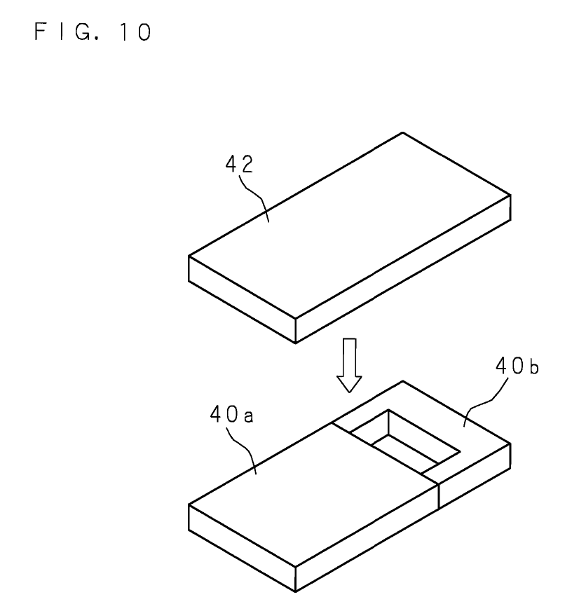

Also, as shown in FIG. 10, a dielectric flat plate 42 having a plate thickness of t and dielectric flat plates 40a, 40b having a plate thickness of (h−t) may be prepared, and the dielectric flat plates 40a, 40b may be bonded and fixed to the dielectric flat plate 42 respectively in a state of being stacked in the plate thickness direction, so as to produce dielectrics 22 with the thickness of the recess region being t and the thickness of the other region being h. In more detail, the dielectric flat plates 40a, 40b have a rectangular shape and an open box shape, respectively, as viewed in a plan view, and the side surface of the dielectric flat plate 40b being open like in an open box is placed to be in contact with the side surface of the dielectric flat plate 40a.

Here, the characteristics of the patch antenna 2 such as the above-described Example 1 and Example 2 were evaluated, and the results of evaluation were similar.

### Embodiment 3

In the embodiment 1 and the embodiment 2, the power supplying part S is disposed at a position having substantially the same distance from the opposing two sides (for example, shorter sides) of the radiation electrode 11, and the thickness of the dielectrics 12 is allowed to differ with a boundary located at a line substantially parallel to the opposing two sides of the radiation electrode 11. However, the thickness of the dielectrics may be allowed to differ with a boundary located at two lines substantially parallel to two pairs of opposing two sides (shorter sides and longer sides) of the radiation electrode 11. The one produced as described above is the embodiment 3.

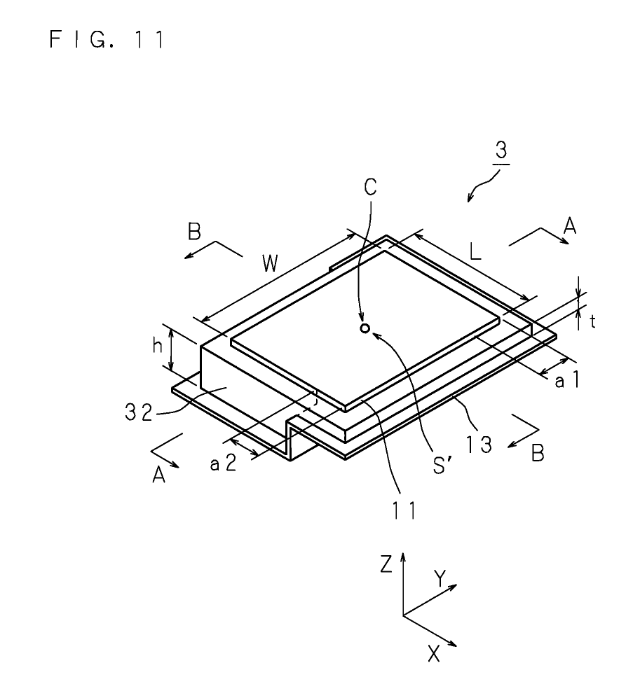

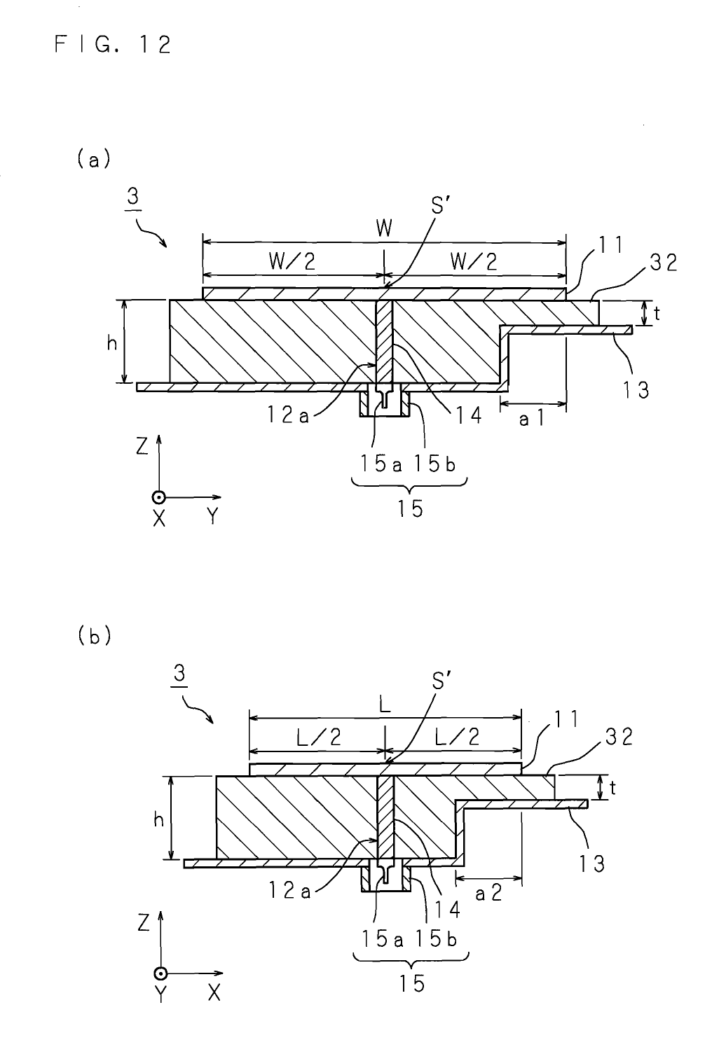

FIG. 11 is a perspective view showing a structure of a patch antenna according to the embodiment 3 of the present invention. Also, FIGS. 12(a) and 12(b) are structural cross-sectional views of a patch antenna according to the embodiment 3 of the present invention, where FIG. 12(a) is a structural cross-sectional view at the line A-A of FIG. 11, and FIG. 12(b) is a structural cross-sectional view at the line B-B of FIG. 11.

In the patch antenna 3 according to the embodiment 3 of the present invention, a radiation electrode 11 being a second conductor and a grounded conductor 13 being a first conductor are disposed to oppose each other, and dielectrics 32 is provided between the radiation electrode 11 and the grounded conductor 13.

The thickness of the dielectrics 32 differs with a boundary located at two lines substantially parallel to two pairs of opposing two sides (namely, shorter sides and longer sides) of the radiation electrode 11. In the present embodiment, the thickness of the dielectrics 32 differs with a boundary located at a position of distance a1 from a terminal side in the longer-side direction (here, −Y direction) of the radiation electrode 11. Further, the thickness of the dielectrics 32 differs with a boundary located at a position of distance a2 from a terminal side in the shorter-side direction (here, −X direction) of the radiation electrode 11. Here, the distances a1 and a2 are both positive (a1, a2>0), and the two boundaries are located at positions that overlap with the radiation electrode 11 as viewed in a plan view. Namely, the thickness of the dielectrics 32 in the upper left side region is h, and the thickness in the right side region and in the lower side region other than the above is t (h>t), so that the shape of the dielectrics 32 is asymmetric relative to the respective center lines of the longer sides and the shorter sides of the radiation electrode 11.

Also, a power supplying part S′ is disposed at the center C of the radiation electrode 11. The other constructions are the same as those of the embodiment 1, so that the detailed description thereof will be omitted by denoting the corresponding parts with the same symbols. Here, the dielectrics 32 may be such that the thickness at a position corresponding to respective one terminal side of the two pairs of opposing two sides of the radiation electrode 11 is smaller than the thickness at the other positions. Also, the power supplying part S′ need not be disposed at the middle point in the shorter-side direction or in the longer-side direction of the radiation electrode 11.

In the patch antenna 3, since the thickness of the dielectrics 32 differs at two boundaries, resonance can be made in the orthogonal two directions (X direction and Y direction) irrespective of the position of the power supplying part S′ to be disposed. In the X direction of the radiation electrode 11, resonance is made in a frequency band substantially corresponding to a single-element antenna that is determined by the length L of the shorter side of the radiation electrode 11. On the other hand, in the Y direction of the radiation electrode 11, resonance is made in a frequency band substantially corresponding to a single-element antenna that is determined by the length W of the longer side of the radiation electrode 11. In this manner, by constructing it so that the thickness of the dielectrics 32 differs at two boundaries, electric waves in two frequency bands can be transmitted and received even if the power supplying part S′ is disposed at the center C of the radiation electrode 11.

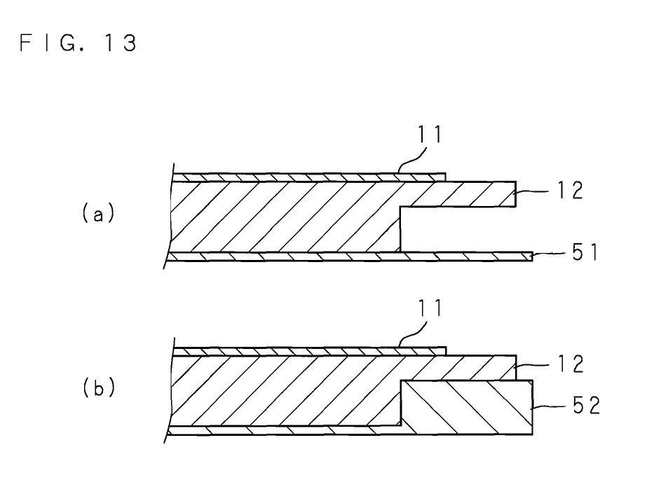

Here, in each embodiment, the grounded conductor 13 is assumed to have a film form, and is placed along the surface shape of the dielectrics 12 (22, 32) (See FIGS. 2, 8, 12(a) and 12(b)). However, as shown in FIGS. 13(a) and 13(b), a grounded conductor 51 having a flat plate shape may be used (FIG. 13(a)), or a grounded conductor 52 having a shape that accords with the recess of the dielectrics 12 (22, 32) may be used (FIG. 13(b)).

Also, though a patch antenna of a single element has been described, improvement in the gain may be attained by using an antenna (referred to as an array antenna) of a form having numerous patch antennas arranged in an array. In this case, though the directivity in the vertical plane is the same as that of one element, the directivity in the horizontal plane will be narrower for the number of disposed patch antennas, so that a vertical polarized wave will be radiated.

As shown above, the patch antenna and the method of producing a patch antenna according to the present invention have been described by showing concrete embodiments. The feature of the present invention lies in a construction such that the power supplying part S is disposed substantially at the center line of the opposing two sides of the rectangular-shaped radiation electrode 11, and the shape of the dielectrics 12 (22, 32) is asymmetric relative to the center line of the opposing two sides of the radiation electrode 11, so that the present invention is not limited to these in the other constructions. Those skilled in the art can add various changes or improvements to the constructions and functions of the invention according to the above-described embodiments within a range that does not depart from the gist of the present invention.

1: A patch antenna comprising:
a first conductor;
a rectangular-shaped second conductor opposing the first conductor and having a power supplying part; and
a dielectrics provided in a gap between the first conductor and the second conductor, wherein
said power supplying part is disposed at a position having substantially the same distance from the opposing two sides of said second conductor, and
a thickness of said dielectrics varies with respect to a boundary at a line substantially parallel to said two sides.

2. (canceled)

3. (canceled)

4: A patch antenna comprising:
a first conductor;
a rectangular-shaped second conductor opposing the first conductor and having a power supplying part; and
a dielectric provided in a gap between the first conductor and the second conductor, wherein
said power supplying part is disposed at a position having substantially the same distance from opposing two sides of said second conductor, and
a thickness of said dielectrics at a position corresponding to one of said two sides is thinner than a thickness of said dielectric at another positions other than the position corresponding to the one of said two sides.

5. (canceled)

6. (canceled)

7: A method of producing a patch antenna in which a first conductor and a second conductor which has a rectangular shape are disposed to oppose each other, and having dielectrics with a different thickness from others in a gap between the first conductor and the second conductor, comprising the steps of:
integrally forming a piece of dielectrics with different thickness by position by bonding to fix a plurality of dielectric flat plates with a different thickness from others;
disposing the first conductor and the second conductor on the formed piece of dielectrics; and
providing a power supplying part at a position having substantially the same distance from opposing two sides of said second conductor.

8: A method of producing a patch antenna in which a first conductor and a second conductor which has a rectangular shape are disposed to oppose each other, and having a piece of integrally bonded dielectrics which has a recess in a gap between the first conductor and the second conductor, comprising the steps of:
forming an opening that penetrates dielectric first flat plate in a depth direction thereof,
forming the piece of dielectrics with the recess by bonding to fix the first flat plate with the opening part and a dielectric second flat plate with a thickness different from that of the first flat plate;
disposing the first conductor and the second conductor on the formed piece of dielectrics; and
providing a power supplying part at a position having substantially the same distance from opposing two sides of said second conductor.
